(19) United States
(12) Patent Application Publication
(10) Pub. No.: US 2026/0118937 A1
(43) Pub. Date: Apr. 30, 2026

(54) VOLTAGE CONTROL AND REGULATION CIRCUIT OF VOLTAGE DROOPS WITH LOW COST AND FAST RESPONSE

(71) Applicant: SOUTHEAST UNIVERSITY, Nanjing (CN)

(72) Inventors: Weiwei SHAN, Nanjing (CN); Zhangrui QIAN, Nanjing (CN); Kaize ZHOU, Nanjing (CN); Yuxuan DU, Nanjing (CN)

(73) Assignee: SOUTHEAST UNIVERSITY, Nanjing (CN)

(21) Appl. No.: 19/478,291

(22) PCT Filed: Oct. 18, 2024
(86) PCT No.: PCT/CN2024/125743

§ 371 Date: Oct. 24, 2025

(30) Foreign Application Priority Data
Feb. 7, 2024 (CN) 202410173439.8

(51) Int. Cl. G06F 1/30; G06F 1/3234; G06F 1/324; G06F 1/3296

(52) U.S. Cl. CPC G06F 1/30; G06F 1/324; G06F 1/3243; G06F 1/3296

(57) ABSTRACT

The provided is a voltage control and regulation circuit of voltage droops with low cost and fast response. The circuit includes: a voltage monitoring unit, a current prediction unit, a voltage loop controller, a current loop controller, a clock gating circuit, and a performance-aware voltage controller. The circuit regulates voltage in real time through a full closed-loop, dual-loop architecture, thereby greatly reducing the performance cost during the regulation. The voltage loop controller and the current loop controller are used in combination, and the frequency adjustment amounts corresponding to the voltage and the current are determined by fitting with different control parameters, thereby implementing a flexible dual-closed-loop control strategy. The frequency adjustment amounts are handled by using a clock gating circuit. The operating frequency of a controlled object is quickly controlled by means of clock enabling.

### CROSS-REFERENCE TO THE RELATED APPLICATIONS

This application is the national phase entry of International Application No. PCT/CN2024/125743, filed on Oct. 18, 2024, which is based upon and claims priority to Chinese Patent Application No. 202410173439.8, filed on Feb. 7, 2024, the entire contents of which are incorporated herein by reference.

### TECHNICAL FIELD

This application relates to the technical field of basic electronic circuits, and in particular, to an on-chip voltage control and regulation circuit of voltage droops with low cost and fast response.

### BACKGROUND

With the rapid development of integrated circuits, a processor is required to handle increasingly complex and diverse tasks, thereby posing severe challenges to the stability of a power delivery network due to drastic load variations. Load variations directly cause changes in a supply current, thereby resulting in voltage droops. This means that the timing margin is insufficient or even fails to meet the minimum requirement, thereby leading to calculation errors. Typically, a voltage droop may be divided into three stages. Among the three stages, the first-stage voltage droop is the most difficult to detect. The frequency and amplitude of the first-stage voltage droop depend on a package inductance and an on-chip capacitance, with the frequency ranging from tens to hundreds of megahertz and the amplitude ranging from tens of millivolts to over one hundred millivolts. When a voltage droop occurs, the voltage needs to be restored by means such as LDO and DC-DC converters to prevent system errors.

In a conventional voltage droop control and regulation system, it usually takes a plurality of cycles to recover and boost the frequency in order to avoid introducing a new voltage droop. However, the whole recovery process takes several microseconds. Consequently, a load that incurs voltage droops frequently severely affects chip performance. If different frequency recovery strategies are designed for droops of varying degrees, such fine-grained differentiation incurs additional hardware cost, increases design difficulty, and also reduces system flexibility. Therefore, a voltage control and regulation circuit of voltage droops with low cost and fast response is required to quickly respond to voltage droops at minimum cost of performance.

### SUMMARY

An objective of this application is to provide a voltage control and regulation circuit of voltage droops with low cost and fast response to overcome the disadvantages and main design challenges in the background technology. Through a fully closed-loop, dual-loop circuit architecture, this application achieves the invention objective of quickly responding to voltage droops based on the frequency adjustment amounts corresponding to the voltage and the current, and solves the problem that an on-chip countermeasure against voltage droops causes excessive impact on system performance and is of low flexibility.

To achieve the above objective, this application puts forward the following technical solutions:

A voltage control and regulation circuit of voltage droops with low cost and fast response is provided, and acts on a controlled object of a chip with an off-chip power supply. The voltage control and regulation circuit includes: a voltage monitoring unit, a current prediction unit, a voltage loop controller, a current loop controller, a clock gating circuit, and a performance-aware voltage controller. The voltage monitoring unit is configured to perform monitoring and generate a voltage code value of the controlled object in a present clock cycle, where the output code value is delayed by 1 to 2 cycles. The current prediction unit is configured to monitor a current code value in the present clock cycle and predict a current code value of the controlled object in a future clock cycle. The voltage loop controller is configured to generate an input-voltage-controlled frequency control signal based on the voltage code value in the present clock cycle and the current code value in the present clock cycle. The current loop controller is configured to generate an input-current-controlled frequency control signal based on the current code value in the future clock cycle. The clock gating circuit is configured to receive the input-voltage-controlled frequency control signal and the input-current-controlled frequency control signal, and generate a clock-enable signal and a global clock signal, where the global clock signal is used for adaptively adjusting a clock frequency of the chip circuit. The performance-aware voltage controller is configured to receive the clock-enable signal output by the clock gating circuit, and generate a voltage regulation instruction used for adaptively regulating an output voltage of the off-chip power supply chip.

In an optimized scheme of the voltage control and regulation circuit of voltage droops with low cost and fast response, the voltage loop controller generates the input-voltage-controlled frequency control signal after performing the following operations on the voltage code value in the present clock cycle and the current code value in the present clock cycle: performing low-pass filtering on the voltage code value in the present clock cycle to obtain a present voltage value, subtracting the present voltage value from a static voltage value to obtain a delayed voltage drop S₁, predicting a present voltage drop F₁ based on the delayed voltage drop S₁ and the current code value in the present clock cycle, and calculating a voltage-controlled frequency control signal V_{cr} based on the delayed voltage drop S₁, the present voltage drop F₁, a target voltage drop T₁, and a proportional coefficient a₁ and a derivative coefficient b₁ of the voltage loop controller, where V_{cf}=(F₋₁−T₁)×a₁+(F₁−S₁)×b₁.

In a further optimized scheme of the voltage control and regulation circuit of voltage droops with low cost and fast response, the current loop controller performs the following operations on the current code value in the future clock cycle to generate an input-current-controlled frequency control signal: obtaining a current code value in the present clock cycle based on the current code value in the future clock cycle, performing average filtering on the current code value in the future clock cycle and the current code value in the present clock cycle to obtain a filtered predicted current value F₂, performing exponential weighted filtering on the current code value in the present clock cycle to obtain a filtered present current value S₂, and calculating a current-controlled frequency control signal I_{cf} based on the filtered predicted current value F₂, the filtered present current value S₂, a target current value T₂, and a proportional coefficient a₂ and a derivative coefficient b₂ of the current loop controller, where I_{cf}=(F₂−T₂)×a₂+(F₂−S₂)×b₂.

In a further optimized scheme of the voltage control and regulation circuit of voltage droops with low cost and fast response, the clock gating circuit includes: an adder, a modulator, and a gated clock unit. One input terminal of the adder receives the input-voltage-controlled frequency control signal, another input terminal of the adder receives the input-current-controlled frequency control signal, and the adder outputs a total frequency control signal. An input terminal of the modulator is connected to an output terminal of the adder, and the modulator outputs a clock-enable signal. An input terminal of the gated clock unit is connected to the output terminal of the modulator, and the gated clock unit outputs a global clock signal.

In a further optimized scheme of the voltage control and regulation circuit of voltage droops with low cost and fast response, the performance-aware voltage controller includes: a cycle timer, a clock gating monitor, and voltage determining logic. The cycle timer is configured to periodically output a count-completion pulse based on a configuration parameter. The clock gating monitor is configured to receive the clock-enable signal and the count-completion pulse, record a count of occurrences of invalid clock-enable signals within one monitoring cycle, and periodically clear the count of occurrences of invalid clock-enable signals under the action of the count-completion pulse. The voltage determining logic is configured to receive the count of occurrences of invalid clock-enable signals output by the clock gating monitor, compare a voltage rise threshold with the count of occurrences of invalid clock-enable signals when the count-completion pulse is valid, and then output a voltage-rise instruction; and compare a voltage fall threshold with the count of occurrences of invalid clock-enable signals when the count-completion pulse is valid, and then output a voltage-fall instruction.

In a further optimized scheme of the voltage control and regulation circuit of voltage droops with low cost and fast response, the current prediction unit is configured to: train and select a flip weight of a system key signal by using a machine learning algorithm, and then multiply each flip monitoring result of the system key signal by the flip weight, accumulate resulting products, and output a prediction result of the current code value in the future clock cycle.

In a further optimized scheme of the voltage control and regulation circuit of voltage droops with low cost and fast response, the low-pass filtering is performed on the voltage code value in the present clock cycle by using a 4th-order low-pass filter implemented in a four-stage pipeline architecture.

In a further optimized scheme of the voltage control and regulation circuit of voltage droops with low cost and fast response, the current code value in the present clock cycle is obtained through a single-stage register based on the current code value in the future clock cycle.

In a further optimized scheme of the voltage control and regulation circuit of voltage droops with low cost and fast response, the modulator is a Δ-Σ modulator.

The voltage control and regulation circuit of voltage droops with low cost and fast response disclosed herein exhibits the following advantages over existing voltage droop control and regulation schemes:
(1) The voltage is regulated in real time by using a fully closed-loop, dual-loop architecture, and the prediction is implemented by using both voltage and current information, thereby greatly reducing the performance cost during the regulation.
(2) The voltage loop controller and the current loop controller are used in combination, and the frequency adjustment amounts corresponding to the voltage and the current are determined by fitting with different control parameters, thereby implementing a flexible dual-closed-loop control strategy.
(3) The frequency control that integrates the detected voltage value, the detected current value, and the predicted value is handled by use of the clock gating circuit to obtain a global clock signal that can quickly control the controlled object. The performance-aware voltage controller and the clock gating circuit are used together, and frequent adjustments are avoided through gate counting. The clock-enable signal is converted into regulation of the voltage of the controlled object, thereby fulfilling the invention objective of simply and efficiently resisting voltage droops,

### BRIEF DESCRIPTION OF THE DRAWINGS

FIG. 1 is a block diagram of a voltage control and regulation circuit of voltage droops with low cost and fast response according to this application;

FIG. 2 is a block diagram of a voltage loop controller according to this application;

FIG. 3 is a block diagram of a low-pass filter in a voltage loop controller according to this application;

FIG. 4 is a block diagram of a current loop controller according to this application;

FIG. 5 is a block diagram of a clock gating circuit according to this application;

FIG. 6 is a block diagram of a performance-aware voltage controller according to this application; and

FIG. 7 is a waveform diagram of signals in a process of controlling and regulating voltage by a circuit according to this application.

### DETAILED DESCRIPTION OF THE EMBODIMENTS

In order to enable better understanding of the objective, structure, and functions of this application, the following describes a prediction circuit for monitoring voltage droops with zero-latency response according to this application in more detail with reference to accompanying drawings.

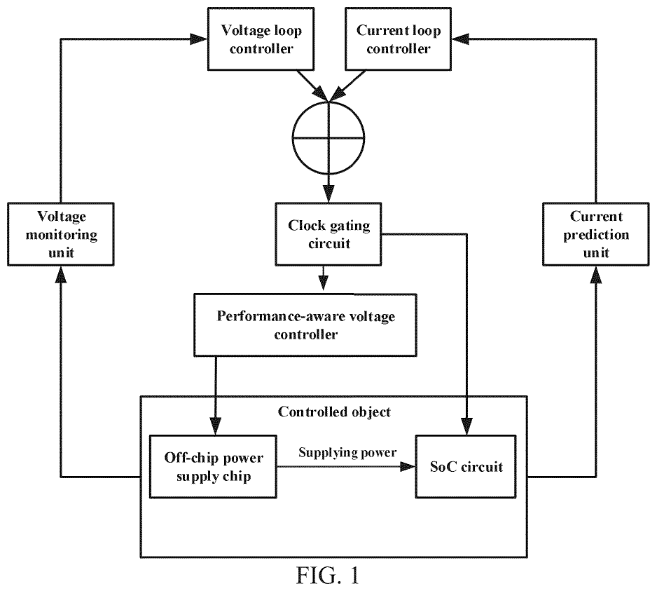

As shown in FIG. 1, a voltage control and regulation circuit of voltage droops with low cost and fast response for a controlled object includes a voltage monitoring unit, a current prediction unit, a voltage loop controller, a current loop controller, a clock gating circuit, and a performance-aware voltage controller. The overall architecture of the circuit is a fully closed-loop system. The controlled object, the voltage monitoring unit, the voltage loop controller, the clock gating circuit, and the performance-aware voltage controller form one loop. The controlled object, the current monitoring unit, the current loop controller, the clock gating circuit, and the performance-aware voltage controller form another loop. The controlled object includes a chip circuit and an off-chip power supply chip supplying power to the chip circuit.

In this embodiment, the voltage control and regulation circuit disclosed in this application is described by using an example in which the controlled object includes a SoC circuit and an off-chip power supply chip supplying power to the SoC circuit.

The voltage monitoring unit is configured to perform monitoring and generate a voltage code value of the controlled object in a present clock cycle, where the output code value is delayed by 1 to 2 cycles. The current prediction unit is configured to monitor a current code value in the present clock cycle and predict a current code value of the controlled object in a future clock cycle. The voltage loop controller is configured to generate an input-voltage-controlled frequency control signal based on the voltage code value in the present clock cycle and the current code value in the present clock cycle. The current loop controller is configured to generate an input-current-controlled frequency control signal based on the current code value in the future clock cycle. The clock gating circuit is configured to receive the input-voltage-controlled frequency control signal and the input-current-controlled frequency control signal, and generate a fast-response clock-enable signal and a global clock signal, where the global clock signal is used for adaptively adjusting a clock frequency of the SoC circuit. The performance-aware voltage controller is configured to receive the clock-enable signal output by the clock gating circuit, and generate a voltage regulation instruction used for adaptively regulating an output voltage of the off-chip power supply chip.

The voltage monitoring unit is a circuit module capable of monitoring the voltage of a to-be-monitored object. The current prediction unit is configured to: train and select a flip weight of a system key signal by using a machine learning algorithm, and then multiply each flip monitoring result of the system key signal by the flip weight, accumulate resulting products, and output a prediction result of the current code value in the future clock cycle, so as to output a monitoring result of the current code value in the present clock cycle while predicting the current of the controlled object.

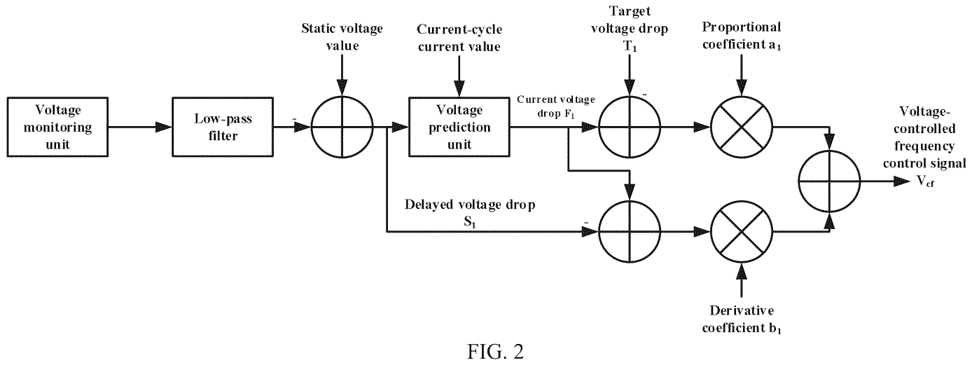

As shown in FIG. 2, the voltage loop controller first sets a target voltage drop, a proportional coefficient, and a derivative coefficient as needed, denoted as T1, a₁, and b₁, respectively. After receiving the voltage code value in the present clock cycle output by the voltage monitoring unit, the voltage loop controller filters out high-frequency noise through a low-pass filter to ensure system stability and outputs a corresponding present voltage value, and subtracts the present voltage value from a static voltage value to obtain an actual delayed voltage drop S₁. The delayed voltage drop S₁ is processed by the voltage prediction unit to obtain an undelayed present voltage drop F₁. A voltage-controlled frequency control signal V_{cr} is calculated based on a combination of the delayed voltage drop S₁, the present voltage drop F₁, the target voltage drop T₁, the proportional coefficient a₁, and the derivative coefficient b₁.

The obtaining of the voltage-controlled frequency control signal includes the following steps:

Step 101: Read the voltage code value in the present clock cycle output by the voltage monitoring unit, and proceed to step 102 if the output voltage code value in the present clock cycle has changed, or proceed to step 101 if the output voltage code value remains unchanged.

Step 102: Let the voltage code value in the present clock cycle output by the voltage monitoring unit pass through a low-pass filter, and then subtract the voltage code value from a static voltage value to complete data preprocessing to obtain a delayed voltage drop. The delayed voltage drop is denoted as S₁. The delayed voltage drop is a code value obtained after the code value of the present voltage drop passes through a register. The process proceeds to step 103.

Step 103: Let the delayed voltage drop S₋₁ and the current code value in the present clock cycle be processed by a voltage prediction unit to obtain a present voltage drop. The present voltage drop is denoted as F₁, and the process proceeds to step 104.

Step 104: Calculate a voltage-controlled frequency control signal V_{cf}=(F₋₁−T₁)×a₁+(F₁−S₁)×b₁.

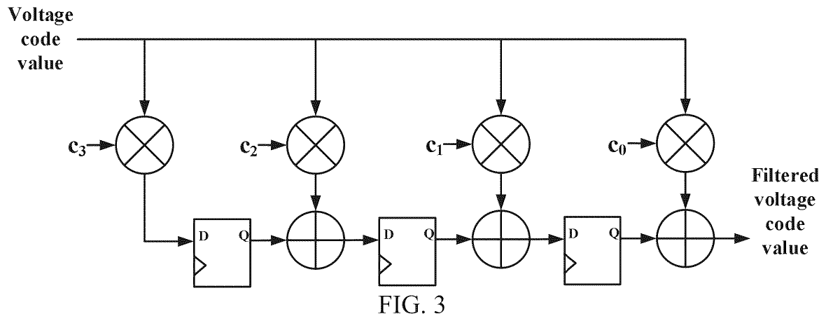

As shown in FIG. 3, the low-pass filter in the voltage loop controller is a 4^{th}-order low-pass filter implemented in a four-stage pipeline architecture. By adjusting the positions of the input, output, and filter coefficient weighting, the critical path length is reduced to a single multiplication-addition stage. By adjusting the filter coefficients, the filter timing is converged to 2 GHz.

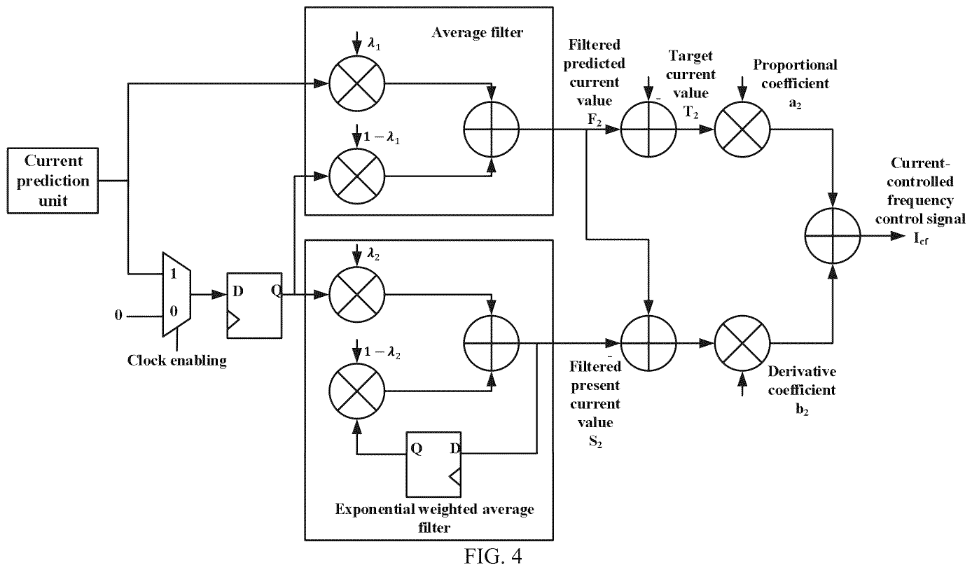

As shown in FIG. 4, the current loop controller first sets a target current value, a proportional coefficient, and a derivative coefficient as needed, denoted as T₂, a₂, and b₂, respectively. After receiving the current code value in the future clock cycle output by the current prediction unit, the current loop controller obtains the current code value in the present clock cycle through a single-stage register, and filters out high-frequency noise by performing average filtering on both the current code value in the future clock cycle and the current code value in the present clock cycle, so as to ensure system stability and output a corresponding filtered predicted current value F₂. In addition, the current loop controller performs exponential weighted filtering on the current code value in the present clock cycle to obtain a filtered present current value S₂, and calculates a current-controlled frequency control signal I_{cf} based on a combination of the filtered predicted current value F₂, the filtered present current value S₂, the target current value T₂, the proportional coefficient a₂, and the derivative coefficient b₂.

The obtaining of the current-controlled frequency control signal includes the following steps:

Step 201: Read the current code value in the future clock cycle output by the current prediction unit, and proceed to step 202 if the output current code value in the future clock cycle has changed, or proceed to step 201 if the output current code value remains unchanged.

Step 202: Pass the current code value in the future clock cycle output by the current prediction unit through a single-stage register to obtain a current code value in the present clock cycle, and then proceed to step 203.

Step 203: Perform average filtering on the current code value in the future clock cycle and the current code value in the present clock cycle to obtain a filtered predicted current value, denote the data of the filtered predicted current value as F₂, and proceed to step 204.

Step 204: Perform exponential weighted filtering on the current code value in the present clock cycle to obtain a filtered present current value, denote the data of the filtered present current value as S₂, and proceed to step 205.

Step 205: Calculate a current-controlled frequency control signal I_{cf}=(F₂−T₂)×a₂+(F₂−S₂)×b₂.

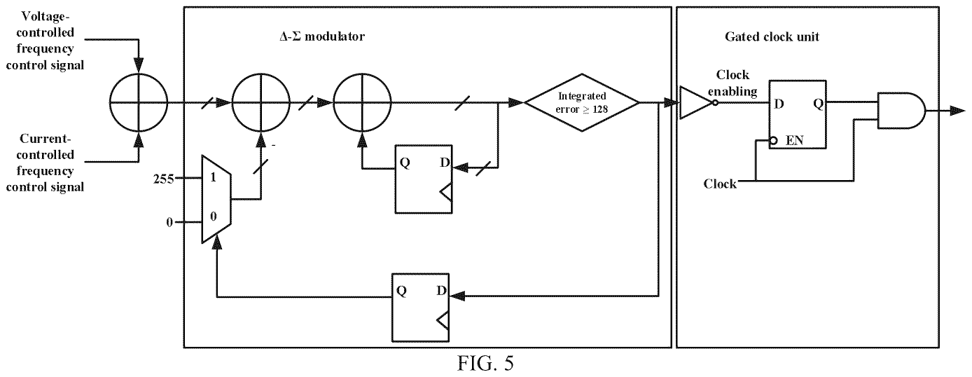

As shown in FIG. 5, the clock gating circuit generates a clock gating signal with reference to the voltage-controlled frequency control signal and the current-controlled frequency control signal, and disables the clock gating signal when the value of the frequency control signal is excessively large. To implement the clock gating regulation circuit, the voltage-controlled frequency control signal and the current-controlled frequency control signal are added first to obtain a total frequency control signal. The total frequency control signal is modulated by a Δ-Σ modulator to obtain a clock gating signal, also known as a clock-enable signal. Subsequently, the clock gating signal is processed by a clock gating unit to output a gated clock signal. The gated clock signal is a global clock signal of the controlled object. The Δ-Σ modulator includes a differencing stage, an integration stage, and a single-bit quantization stage. In the differencing stage, an output error is calculated based on a feedback signal. In the integration stage, the error is integrated. Subsequently, the integrated error is processed by a single-bit quantizer to output a single-bit signal. Continuous feedback adjustment ensures that the integrated error remains within a specified range, thereby enabling the output signal to track the input signal. The clock gating circuit can complete the adjustment within a single cycle, thereby offering the advantage of fast response.

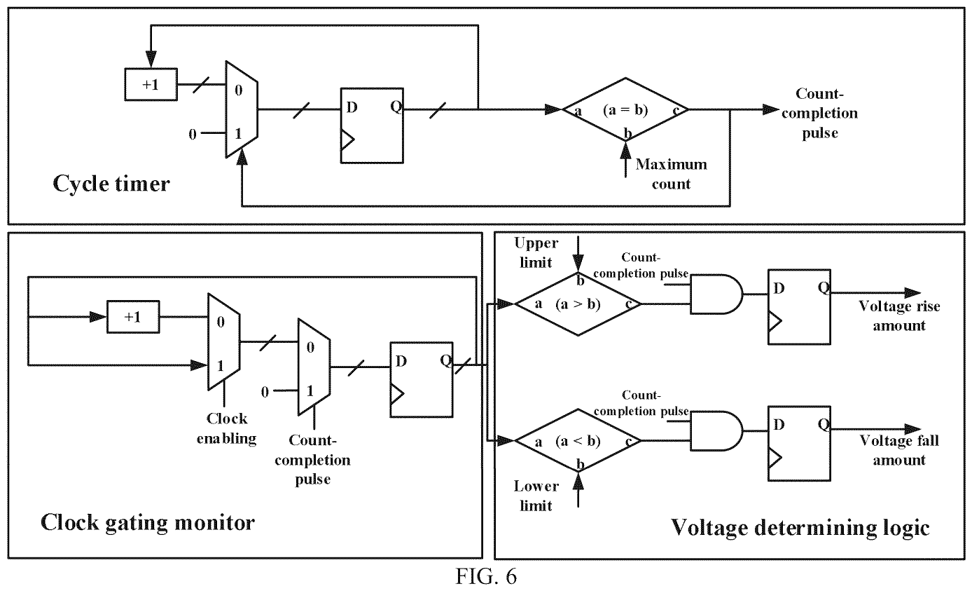

As shown in FIG. 6, the performance-aware voltage controller receives a clock-enable signal generated by the clock gating circuit, and measures the proportion of clock gating to detect the performance degradation caused by gating regulation. This information is used as a guidance for the off-chip power supply chip to regulate the supply voltage. First, a cycle timer periodically outputs a count-completion pulse based on a configuration parameter. Subsequently, the clock gating monitor is reset periodically based on the count-completion pulse signal, records the count of invalid clock-enable signals transmitted from the clock gating circuit in one monitoring cycle, and outputs a cumulative value of the count values. Finally, when the count-completion pulse is valid, the voltage determining logic compares a voltage rise threshold and a voltage fall threshold with the cumulative value of the counts of invalid clock-enable signals separately, and outputs a voltage-rise instruction and a voltage-fall instruction. The off-chip power supply chip regulates the output voltage based on the two signals the voltage-rise instruction and the voltage-fall instruction, thereby implementing performance-aware voltage regulation.

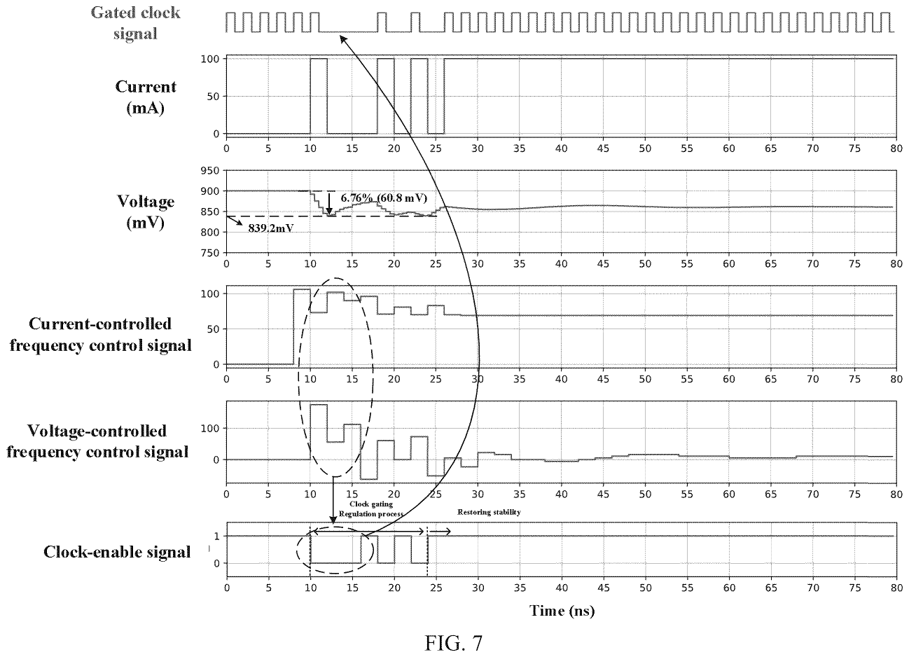

As shown in FIG. 7, current excitation is applied at a time point of 10 ns to induce a voltage variation. The current loop controller has adopted the predicted dynamic current information, and therefore, can generate a current-controlled frequency control signal before the voltage starts to drop. Subsequently, because the predicted dynamic current always matches the amplitude of the step current, the current-controlled frequency control signal stays at a relatively high level. At the time point of 10 ns, based on the data output by the voltage monitoring unit, the voltage loop controller detects that the voltage is in a drooping stage, and therefore, outputs a relatively large value of the voltage-controlled frequency control signal. Subsequently, because the voltage is gradually stabilized, the voltage-controlled frequency control signal also gradually decreases. Based on the current-controlled frequency control signal and the voltage-controlled frequency control signal, the clock gating circuit determines whether to perform clock gating. At the time point of 10 ns, because both the voltage-controlled frequency control signal and the current-controlled frequency control signal are of a relatively large value, the clock-enable signal is pulled low. Subsequently, at a time point of 12 ns, the gated clock signal no longer outputs a rising edge, and therefore, the dynamic current also returns to zero. The clock-enable signal is not reactivated until the voltage returns to a relatively high level. After a plurality of adjustments, the voltage is gradually stabilized, and the gated clock signal also restores the normal frequency.

Understandably, this application is described with reference to some embodiments. A person skilled in the art may make various changes or equivalent substitutions to the features and embodiments without departing from the essence and scope of this application. In addition, based on the teachings of this application, the features and embodiments may be modified to adapt to specific circumstances without departing from the essence and scope of this application. Therefore, this application is not limited to the specific embodiments disclosed herein, and all embodiments falling within the scope of the claims hereof are covered by the scope of protection of this application.

What is claimed is:

1. A voltage control and regulation circuit of voltage droops with low cost and fast response, acting on a controlled object of a chip with an off-chip power supply, wherein the voltage control and regulation circuit comprises:
a voltage monitoring unit, configured to perform monitoring and generate a voltage code value of the controlled object in a present clock cycle, wherein the output code value is delayed by 1 to 2 cycles;
a current prediction unit, configured to monitor a current code value in the present clock cycle and predict a current code value of the controlled object in a future clock cycle;
a voltage loop controller, configured to generate an input-voltage-controlled frequency control signal based on the voltage code value in the present clock cycle and the current code value in the present clock cycle;
a current loop controller, configured to generate an input-current-controlled frequency control signal based on the current code value in the future clock cycle;
a clock gating circuit, configured to receive the input-voltage-controlled frequency control signal and the input-current-controlled frequency control signal, and generate a clock-enable signal and a global clock signal, wherein the global clock signal is used for adaptively adjusting a clock frequency of a chip circuit; and
a performance-aware voltage controller, configured to receive the clock-enable signal output by the clock gating circuit, and generate a voltage regulation instruction used for adaptively regulating an output voltage of an off-chip power supply chip.

2. The voltage control and regulation circuit of the voltage droops with the low cost and the fast response according to claim 1, wherein the voltage loop controller generates the input-voltage-controlled frequency control signal after performing the following operations on the voltage code value in the present clock cycle and the current code value in the present clock cycle: performing low-pass filtering on the voltage code value in the present clock cycle to obtain a present voltage value, subtracting the present voltage value from a static voltage value to obtain a delayed voltage drop S₁, predicting a present voltage drop F₁ based on the delayed voltage drop S₁ and the current code value in the present clock cycle, and calculating a voltage-controlled frequency control signal V_{cf} based on the delayed voltage drop S₁, the present voltage drop F₁, a target voltage drop T₁, and a proportional coefficient al and a derivative coefficient b₁ of the voltage loop controller, wherein V_{cf}=(F₋₁−T₁)×a₁+(F₁−S₁)×b₁.

3. The voltage control and regulation circuit of the voltage droops with the low cost and the fast response according to claim 1, wherein the current loop controller performs the following operations on the current code value in the future clock cycle to generate an input-current-controlled frequency control signal: obtaining a current code value in the present clock cycle based on the current code value in the future clock cycle, performing average filtering on the current code value in the future clock cycle and the current code value in the present clock cycle to obtain a filtered predicted current value F₂, performing exponential weighted filtering on the current code value in the present clock cycle to obtain a filtered present current value S₂, and calculating a current-controlled frequency control signal I_{cf} based on the filtered predicted current value F₂, the filtered present current value S₂, a target current value T₂, and a proportional coefficient a₂ and a derivative coefficient b₂ of the current loop controller, wherein I_{cf}=(F₂−T₂)×a₂+(F₂−S₂)×b₂.

4. The voltage control and regulation circuit of the voltage droops with the low cost and the fast response according to claim 1, wherein the clock gating circuit comprises:
an adder, wherein one input terminal of the adder receives the input-voltage-controlled frequency control signal, another input terminal of the adder receives the input-current-controlled frequency control signal, and the adder outputs a total frequency control signal;
a modulator, wherein an input terminal of the modulator is connected to an output terminal of the adder, and the modulator outputs a clock-enable signal; and
a gated clock unit, wherein an input terminal of the gated clock unit is connected to an output terminal of the modulator, and the gated clock unit outputs a global clock signal.

5. The voltage control and regulation circuit of the voltage droops with the low cost and the fast response according to claim 1, wherein the performance-aware voltage controller comprises:
a cycle timer, configured to periodically output a count-completion pulse based on a configuration parameter;
a clock gating monitor, configured to receive the clock-enable signal and the count-completion pulse, record a count of occurrences of invalid clock-enable signals within one monitoring cycle, and periodically clear the count of occurrences of invalid clock-enable signals under an the action of the count-completion pulse; and
voltage determining logic, configured to receive the count of occurrences of invalid clock-enable signals output by the clock gating monitor, compare a voltage rise threshold with the count of occurrences of invalid clock-enable signals when the count-completion pulse is valid, and then output a voltage-rise instruction; and compare a voltage fall threshold with the count of occurrences of invalid clock-enable signals when the count-completion pulse is valid, and then output a voltage-fall instruction.

6. The voltage control and regulation circuit of the voltage droops with the low cost and the fast response according to claim 1, wherein the current prediction unit is configured to: train and select a flip weight of a system key signal by using a machine learning algorithm, and then multiply each flip monitoring result of the system key signal by the flip weight, accumulate resulting products, and output a prediction result of the current code value in the future clock cycle.

7. The voltage control and regulation circuit of the voltage droops with the low cost and the fast response according to claim 2, wherein the low-pass filtering is performed on the voltage code value in the present clock cycle by using a 4^{th}-order low-pass filter implemented in a four-stage pipeline architecture.

8. The voltage control and regulation circuit of the voltage droops with the low cost and the fast response according to claim 3, wherein the current code value in the present clock cycle is obtained by use of a single-stage register based on the current code value in the future clock cycle.

9. The voltage control and regulation circuit of the voltage droops with the low cost and the fast response according to claim 4, wherein the modulator is a delta-sigma (Δ-Σ) modulator.
